(19) United States
(12) Patent Application Publication
(10) Pub. No.: US 2020/0034859 A1
(43) Pub. Date: Jan. 30, 2020

(54) SYSTEM AND METHOD FOR PREDICTING STOCK ON HAND WITH PREDEFINED MARKDOWN PLANS

(71) Applicant: Walmart Apollo, LLC, Bentonville, AR (US)

(72) Inventors: Abhishek SENGUPTA, Bangalore (IN); Abhishek SRIVASTAVA, Bangalore (IN); Biswajit PAL, Bangalore (IN)

(73) Assignee: Walmart Apollo, LLC, Bentonville, AR (US)

(21) Appl. No.: 16/521,744

(22) Filed: Jul. 25, 2019

Related U.S. Application Data
(60) Provisional application No. 62/773,690, filed on Nov. 30, 2018.

(30) Foreign Application Priority Data
Jul. 26, 2018 (IN) 201811028180

(51) Int. Cl. G06Q 30/02; G06Q 10/08

(52) U.S. Cl. CPC G06Q 30/0202; G06Q 10/0875

(57) ABSTRACT

Systems and methods for predicting stock on hand for predefined markdown plans are provided. An example method can include retrieving retail item sales data; aggregating normal sales and markdown sales; converting normal sales and markdown sales to a weekly time series normal sales and a weekly time series markdown sales; creating a plurality of disruptive time series; receiving one or more markdown plans; performing prediction on each disruptive time series; obtaining an average of predictions from each disruptive time series to find a final sales prediction; calculating a predicted stock on hand; and rerunning the disruptive time series model to automatically recalculate the predicted stock on hand and the predicted incremental impact in real time when the processor receives a change made on the markdown plans.

### CROSS-REFERENCE TO RELATED APPLICATIONS

This patent application claims the priority to Indian Patent Application No.: 201811028180, filed Jul. 26, 2018, and U.S. Provisional Application No. 62/773,690, filed Nov. 30, 2018, contents of which are incorporated by reference herein.

### BACKGROUND

### 1. Technical Field

The present disclosure relates to a system and method for creating a new time series data from original data structure generated by a computing devices.

### 2. Introduction

Inventory and price management generally includes a markdown strategy for a retailer to make decisions on product price and inventory in order to maintain and maximize a retail store revenue over an entire product lifecycle. Delivering markdown recommendations for a product across its entire life cycle with the optimized timing and depth of each markdown can ensure the retailer optimally manage their product inventory. For example, in a retailer next generation pricing (NGP) platform, retailer pricing managers (e.g., users) may be allowed to create markdown plans much ahead in time.

However, the existing price management system cannot predict the variation in stock on hand (e.g., inventory on hand) with markdown changes. The existing system assumes the stock on hand (SOH) for all reviews to be the same as the initial stock on hand. For example, Table 1 below shows a three-week markdown plan with an initial stock of 100 units in the existing price management.

TABLE 1

| Week | Markdown % | Predicted Stock on Hand |
|---|---|---|
| 1 | 25% | 100 |
| 2 | 50% | 100 |
| 3 | 70% | 100 |

As illustrated in the table 1, the existing price management system may predict the markdown and the stock on hand for each week to be equal to the initial stock on hand, irrespective of markdowns given at each week. The existing system does not take into account how much ahead of time the markdown plan is made and does not adapt itself to the varying time-spans of the markdown plans. Thus, the existing system cannot distinguish between, for example, a three-week markdown plan made one month ahead, versus, the-week markdown plan made two months ahead.

Since the existing system doesn't take into account the sales history of the item or the sales history associated with the store, it cannot provide store-item specific forecasts and monitor the sales and hence cannot update its forecasts.

There is a need to use an optimized markdown strategy to forecast inventory depletion for retailers and to decide when and how much a markdown needs to be scheduled for every item in the inventory by considering store-item sales history and specific markdown plan suggestions provided by pricing managers. There is also a need to generate relevant metrics, compare several markdown plans, and provide specific markdown plans for items.

### SUMMARY

An example computer-implemented method of performing concepts disclosed herein can include: retrieving, by a processor of a computing device, retail item sales data from a database; aggregating, by the processor, normal sales and markdown sales associated to an item and one or more stores over a given period; converting, by the processor, normal sales and markdown sales to a weekly time series normal sales and a weekly time series markdown sales; creating, using a disruptive time series model, a plurality of disruptive time series, wherein each disruptive time series is created by: splicing different parts of the weekly time series normal sales at random points; and inserting the weekly time series markdown sales at corresponding points to spliced regions of the weekly time series normal sales until all the points in the weekly time series markdown sales are exhausted, receiving, via a user interface, one or more markdown plans predefined by a user, the markdown plans comprising a plurality of review gates; performing prediction on each disruptive time series using a Seasonal Autoregressive Integrated Moving Average (SARIMA) model with exogenous input X being trained on the disruptive time series to predict a stock on hand for the predefined markdown plans at each review gate; obtaining an average of predictions from each disruptive time series to find a final sales prediction at each review gate; calculating, using the final sales prediction, a predicted stock on hand and a predicted incremental impact at each gate; and rerunning the disruptive time series model to automatically recalculate and display the predicted stock on hand and the predicted incremental impact in real time when the processor receives a change made on the markdown plans.

An example system configured according to the concepts and principles disclosed herein can include: a processor; and non-transitory computer-readable storage medium having instructions stored which, when executed by the processor, cause the processor to perform operations comprising: retrieving, by a processor of a computing device, retail item sales data from a database; aggregating, by the processor, normal sales and markdown sales associated to an item and one or more stores over a given period; converting, by the processor, normal sales and markdown sales to a weekly time series normal sales and a weekly time series markdown sales; creating, using a disruptive time series model, a plurality of disruptive time series, wherein each disruptive time series is created by: splicing different parts of the weekly time series normal sales at random points; and inserting the weekly time series markdown sales at corresponding points to spliced regions of the weekly time series normal sales until all the points in the weekly time series markdown sales are exhausted, receiving, via a user interface, one or more markdown plans predefined by a user, the markdown plans comprising a plurality of review gates; performing prediction on each disruptive time series using a Seasonal Autoregressive Integrated Moving Average (SARIMA) model with exogenous input X being trained on the disruptive time series to predict a stock on hand for the predefined markdown plans at each review gate; obtaining an average of predictions from each disruptive time series to find a final sales prediction at each review gate; calculating, using the final sales prediction, a predicted stock on hand and a predicted incremental impact at each gate; and rerunning the disruptive time series model to automatically recalculate and display the predicted stock on hand and the predicted incremental impact in real time when the processor receives a change made on the markdown plans.

A computer program product being embodied thereon a non-transitory computer-readable storage medium and comprising instructions which, when executed by at least one computing device, are configured to cause the at least one computing device to perform operations including: retrieving, by a processor of a computing device, retail item sales data from a database; aggregating, by the processor, normal sales and markdown sales associated to an item and one or more stores over a given period; converting, by the processor, normal sales and markdown sales to a weekly time series normal sales and a weekly time series markdown sales; creating, using a disruptive time series model, a plurality of disruptive time series, wherein each disruptive time series is created by: splicing different parts of the weekly time series normal sales at random points; and inserting the weekly time series markdown sales at corresponding points to spliced regions of the weekly time series normal sales until all the points in the weekly time series markdown sales are exhausted, receiving, via a user interface, one or more markdown plans predefined by a user, the markdown plans comprising a plurality of review gates; performing prediction on each disruptive time series using a Seasonal Autoregressive Integrated Moving Average (SARIMA) model with exogenous input X being trained on the disruptive time series to predict a stock on hand for the predefined markdown plans at each review gate; obtaining an average of predictions from each disruptive time series to find a final sales prediction at each review gate; calculating, using the final sales prediction, a predicted stock on hand and a predicted incremental impact at each gate; and rerunning the disruptive time series model to automatically recalculate and display the predicted stock on hand and the predicted incremental impact in real time when the processor receives a change made on the markdown plans.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Example embodiments of this disclosure are illustrated by way of an example and not limited in the figures of the accompanying drawings, in which like references indicate similar elements and in which:

FIG. 1 is an exemplary block diagram illustrating an example environment in accordance with some embodiments of the present invention;

FIG. 2 is an exemplary functional block diagram illustrating a system for predicting stock on hand with predefined markdown plans in accordance with some embodiments;

FIG. 3 is an exemplary flowchart diagram illustrating a process using a disruptive time series algorithm in accordance with some embodiments;

FIG. 4 is an exemplary diagram displaying normal sales in accordance with some embodiments;

FIG. 5 is an exemplary diagram displaying markdown sales in accordance with some embodiments;

FIG. 6 is an exemplary diagram displaying splicing of normal sales data with observations spliced at random points in accordance with some embodiments;

FIG. 7 is an exemplary diagram displaying markdown sales with markdown series corresponding the spliced random points in the normal sales data corresponding observation in accordance with some embodiments;

FIG. 8 is an exemplary diagram illustrating the final sales prediction with observation markdown observation in accordance with some embodiments;

FIG. 9 is an exemplary table illustrating a predefined markdown plan in accordance with some embodiments;

FIG. 10 is an exemplary table illustrating a predicted final sales in accordance with some embodiments;

FIG. 11 is an exemplary table illustrating a comparison of predicted results between the disclosed system and the existing system in accordance with some embodiments;

FIG. 12 is an exemplary table illustrating a predicted final sales for different items in different stores in accordance with some embodiments; and

FIG. 13 is an exemplary block diagram an example computer system in which some example embodiments may be implemented.

It is to be understood that both the foregoing general description and the following detailed description are example and explanatory and are intended to provide further explanations of the invention as claimed only and are, therefore, not intended to necessarily limit the scope of the disclosure.

### DETAILED DESCRIPTION

Various example embodiments of the present disclosure will be described in detail below with reference to the accompanying drawings. Throughout the specification, like reference numerals denote like elements having the same or similar functions. While specific implementations and example embodiments are described, it should be understood that this is done for illustration purposes only. Other components and configurations may be used without parting from the spirit and scope of the disclosure, and can be implemented in combinations of the variations provided. These variations shall be described herein as the various embodiments are set forth.

The present disclosure is directed to systems and methods providing a novel disruptive time series algorithm. Embodiments of the invention may be used to predict stock on hand with predefined markdown (MD) plans for a plurality of items in retail stores. Retail sales transactions for a large number of items are acquired by hardware computing devices (e.g., Point-of-Sale devices) in retail stores or via a retailer's online commercial website. The system may be implemented by a computer program product which is configured to retrieve the raw item sales transaction data across a number of retail stores and to convert the associated item sale information to time series for normal sales and markdown sales. Further, the system can be configured to build a mixed disruptive time series model to splice normal data and insert revised data based on the user defined plans or the system suggested plans. The system may use machine learning models to analyze and forecast time series data of normal data and revised data to predict the future data in the time series. For example, an auto-regressive moving average model with an exogenous input may be used on the mixed disruptive time series. The system uses mixed disruptive time series to compute predicted stock on hand for each of a plurality of items. The system reruns the time series model to recompute the predicted stock on hand and predicted incremental impacts when the computing device receives a change made on one or more markdown plans. In the present disclosure, pricing managers may generally be referred to as users of a price management system. A user may be allowed to create markdown plans much ahead in time with up to 6 review gates. For example, the users use a retailer next generation pricing (NGP) platform to create over 10,000 markdown plans per year with up to 6 review gates for items sold in retail stores. A user needs to know the financial impact at each review gate (e.g., each week) and it corresponding effective date in the future. The incremental impact of markdown gates in the plan needs to be calculated based on the predicted stock on hand for each of the markdown gates. To predict or forecast stock on hand for various gates, the system needs to take current stock on hand for first gate and reduce the stock on hand for each subsequent gate based on the burn rate calculated by the system. This can provide more reliable financial impacts created by markdown plans. Burn Rate is defined as the rate of sales of items between subsequent review gates in which the system predicts using a Disruptive Time Series Model. In the present system, a calculated incremental impact at each review gate for an item is a value that the predicted burn rate of the model times a marked down price.

Currently, there is no way to understand how the stock on hand can reduce over a period of time. The current system assumes stock on hand for all reviews to be same as the current value of the stock on hand. If a system can forecast how the stock on hand may reduce based on the markdown plan, the impact calculation may be much more accurate. Accurate forecasts of the impacts of markdown plans at the time of formulating the plans may help mitigate retailer losses and maximize revenue.

The system in the present disclosure can provide the following exclusive features in comparison with existing systems:
1) the system allows users to enter and compare multiple markdown plans;
2) the system provides live forecasts when the markdown plan is actually live in the store;
3) the system provides additional relevant metrics corresponding to the markdown plan which can help users in evaluating their plans;
4) the system adds functionality to allow the user to change mark down plans midway and analyze their forecasted effects via a user interface; and
5) the system suggests most optimal plans to the user which the user can adopt at his/her discretion.

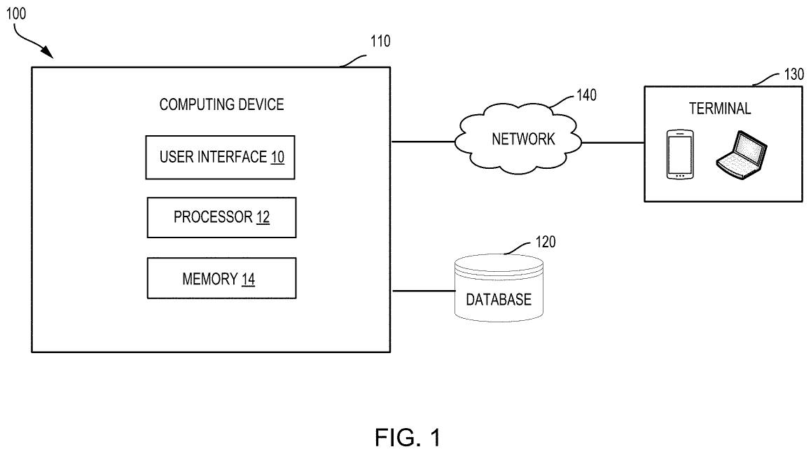

FIG. 1 is a block diagram illustrating an example computing system 100 in which some example embodiments may be implemented. The example computing system 100 generally includes a computing device 110, a database 120, a terminal 130, and network 140.

The computing device 110 may be a local server or a computer terminal associated with a retailer. The computing device 110 may include user interface 10, processor 12 and memory 14. The memory 14 may store various calculation modules or executed instructions/applications to be executed by the processor 12.

The computing device 110 communicates with the database 120 to execute one or more sets of processes. The database 120 may be communicatively coupled to the computing device 110 to receive instructions or data from and send data to the computing device 110 via network 140. The product historical sales data and product information associated with each of a plurality of items may be stored in the database 120. In some embodiments, the database 120 may store sale transaction history during a period of time (e.g., a few years) which includes all purchased records in retail stores. The sale transaction history of an item may include item name, normal price, purchase time, markdown percentage (%), markdown price, store number, etc. The database may dynamically update product information according to updated item stock on hand and markdown plans. The product information associated with an item may include store number, item number, stock on hand, retail price, week number, review gate number (e.g., markdown week number), actual sales, markdown retail price, predicted sales, actual revised stock on hand (SOH).

The terminal 130 may represent at least one of a portable device, a tablet computer, a notebook computer, or a desktop computer that allows the user to communicate with the computing device 110 and perform online activities via network 140.

The network 140 may include satellite-based navigation system or a terrestrial wireless network, Wi-Fi, and other type of wired or wireless networks to facilitate communications between the various network devices associated with the example computing system 100.

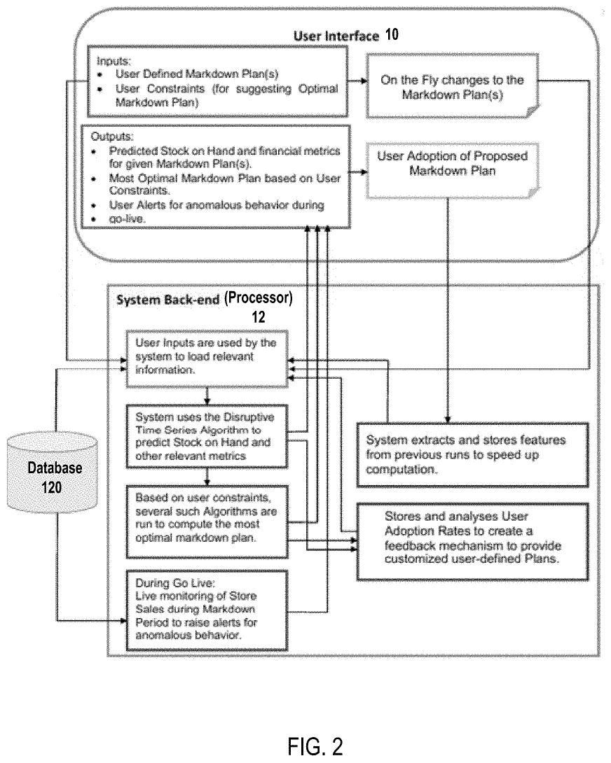

FIG. 2 is an exemplary functional block diagram illustrating a system for predicting stock on hand with predefined markdown plans in accordance with some embodiments.

The system features the user interface 10 for receiving a user predefined markdown plan loaded or entered by the user. Each markdown plan associated with an item may be represented by a dataset including item number, store number, item description, week number, retail price, mark down percentage (%), markdown price, etc. The user interface 10 may receive inputs from the users including user defined markdown plans and user constraints for suggesting an optimal markdown plan. The user may edit or modify a markdown plan midway and make on the fly changes to the markdown plan via the user interface 10.

The user interface 10 may be used to display a variety of processed information including:
1) predicted stock on hand;
2) financial metrics for given markdown plans;
3) most optimal markdown plan based on user constraints; and
4) user alerts for anomalous behavior during go-live.

The user interface 10 may further display a user adoption of proposed markdown plan and send it back to the user interface 10 as an input. The financial metrics for a given markdown plan may include loss of revenue due to markdown, waste value, etc.

The system can provide a forecasted stock on hand value by looking into past sales history retrieved from the database and combine relevant features using a novel disruptive time series model (e.g., algorithm) to increase an accuracy of predicting stock on hand substantially.

The forecasted stock on hand is store-item specific and may be based on the store and item sales history. The store or inventory forecasting may be conducted for different stores and different items. The forecasts may vary for stores and items based on the predefined markdown plan and particular sales status or history.

The markdown plan is usually made well or predefined in advance (e.g., 2 or 3 months) before its actual implementation in a retail store. The system can take into account this time lag. The time-span of a markdown plan is referred to as a time period during which the markdown plan is implemented in the store. The time-span of the markdown plan may be varied and range any time period from 1 week to 2 months. The system can provide forecasts for any time-span based on a defined markdown plan.

The system can monitor the sales during the time markdown plan is live in a store, and automatically update its forecasts based on the current sales. Thus, the user can receive live updates on how the user markdown plan performs at the store. Apart from predicting stock on hand, the system also predicts relevant metrics from the markdown plan, such as loss of revenue due to markdown, waste value, etc. Since revenue metrics are a by-product of stock on hand, the system automatically calculates the revenue metrics including loss of revenue, waste value, etc. The relevant metrics can be returned to the user. For example, if the system predicts the stock on hand at the end of the markdown plan to be 20 units, and if the initial stock on hand was 100 units, the regular cost of the item was $1, the system may compute a waste value of $80 and return it to the user.

In the example stated above, the system returns a waste value of $80 as per an initial markdown plan. The user can dynamically adjust a waste threshold. For example, if the user sets a maximum waste threshold to be $60, the system may use Dynamic Optimization (from the Trained Historical Data) to increase the markdown percentage (%) at each Gate.

For example, the user-defined markdown (MD) plan is shown in Table 2 below.

TABLE 2

| Week No. | Markdown % |
|---|---|
| 1 | 10% |
| 2 | 14% |
| 3 | 24% |

The system returns suggested markdown plans which is shown in Table 3 below.

TABLE 3

| Week No. | Markdown % |
|---|---|
| 1 | 13% |
| 2 | 16% |
| 3 | 29% |

The system enables the user to enter multiple markdown plans and compare the effects of each of the plans. The system may add functionality so that the user has an option to edit or modify a markdown plan midway, and the system can adapt to show the corresponding modified stock on hand. The system can also suggest the best optimal markdown plan based on user-specific criterion in which the user can adopt according to his/her discretion. The system can learn individual user behaviors over time and suggest personalized user-specific markdown plans.

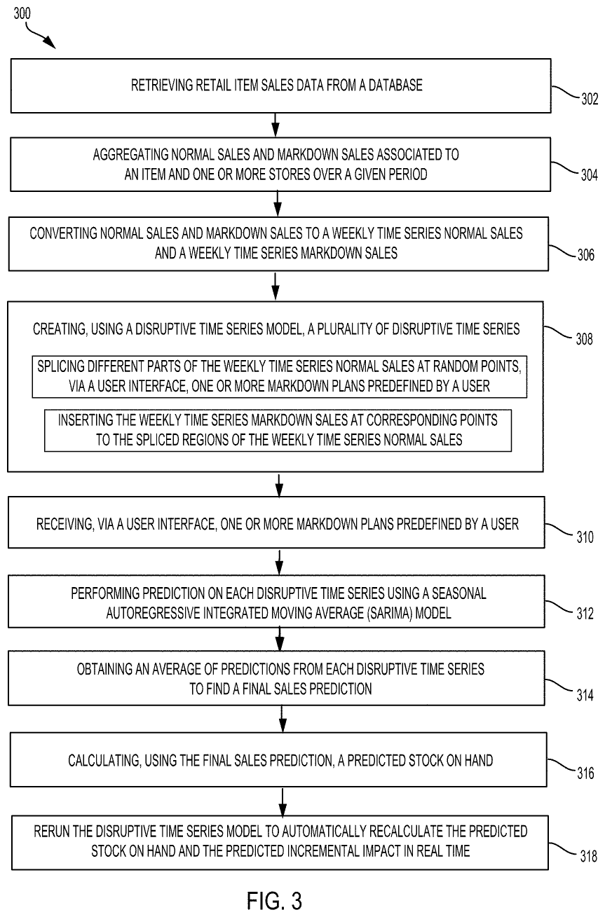

FIG. 3 is an exemplary flowchart diagram illustrating a process using a disruptive time series algorithm in accordance with some embodiments.

The process 300 may be implemented in the above described systems and may include the following steps. Steps may be omitted or combined depending on the operations being performed. In some embodiments, the system can measure and predict how the stock on hand reduces over a period of time and when price markdowns are considered.

In step 302, the system may retrieve sales data associated to an item one or more stores from a database over a given period.

If markdown plans for the same store-item combination are entered in a previous run, similar computation may have been performed in history by the system and may automatically been stored in the database of the system. The system can access and obtain the previous stored information from the database to speed up computation.

In step 304, the normal sales and markdown sales are aggregated to be associated with the item and one or more stores over a given period. Ideally, the system can capture the majority of the underlying trend, seasonality and cyclical pattern from tₙₒᵣₘₐₗ and all of the pricing information from t_{markdown}, with some information about the trend and seasonal information from t_{markdown}.

In step 306, the aggregated information may be converted to two weekly-sales time series, one for regular/normal sales tₙₒᵣₘₐₗ, and the other for markdown sales t_{markdown}. If the aggregation is made across a plurality of stores, the normal and markdown sales data are averaged out respectively before constructing the two time series.

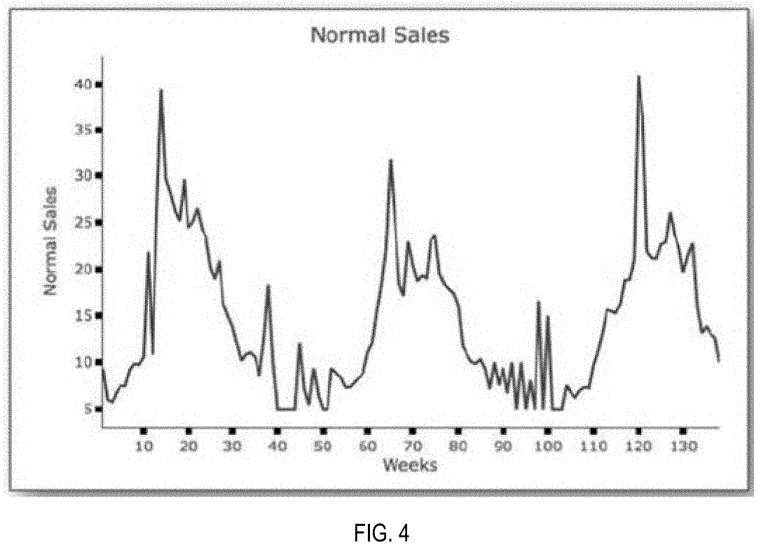

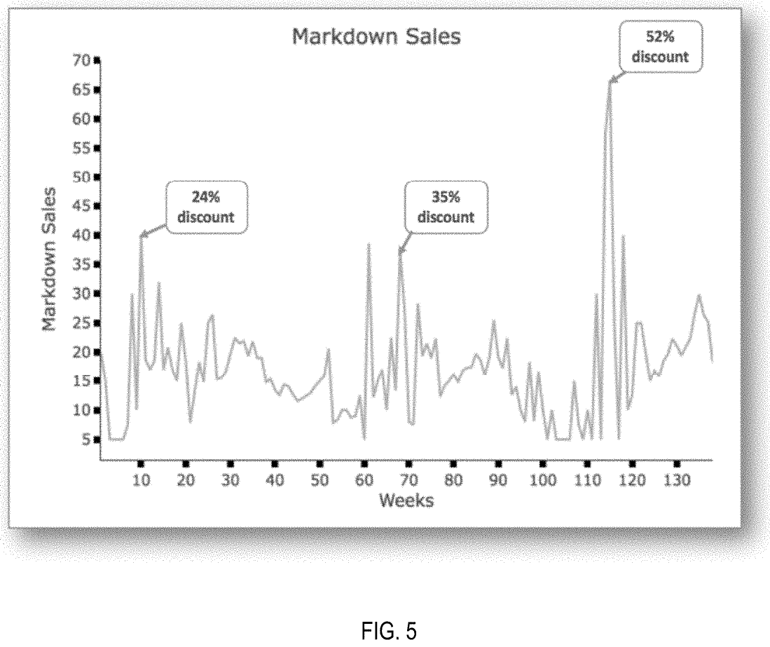

FIG. 4 shows an exemplary diagram illustrating normal sales. The x-axis represents a time variable in week over a two-year period. The y-axis represents normal sales of an item at a particular week. The normal sales for a plurality of weeks are converted to a weekly time series normal sales data. FIG. 5 is an exemplary diagram illustrating markdown sales. The markdown sales for a plurality of weeks are converted to a weekly time series markdown sales data. The x-axis represents a time variable in week over a two-year period. The y-axis represents markdown sales of the item at a particular week.

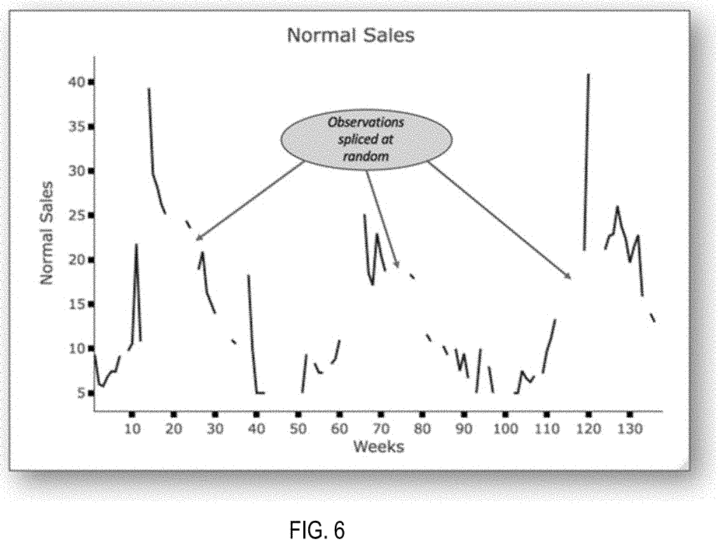

In step 308, a disruptive time series model is built to splice tₙₒᵣₘₐₗ at random points (which are roughly selected as one third of the total length of the series) and insert the corresponding points from t_{markdown} to create a disruptive time series. FIG. 6 is an exemplary diagram displaying splicing of normal sales data with observations spliced at random points along the x-axis. A plurality of disruptive time series are created. Each disruptive time series is created by splicing different parts of the weekly time series normal sales at random points, and inserting the weekly time series markdown sales at corresponding points to the spliced regions of the weekly time series normal sales until all the points in the weekly time series markdown sales are exhausted or completed being inserted in disruptive time series.

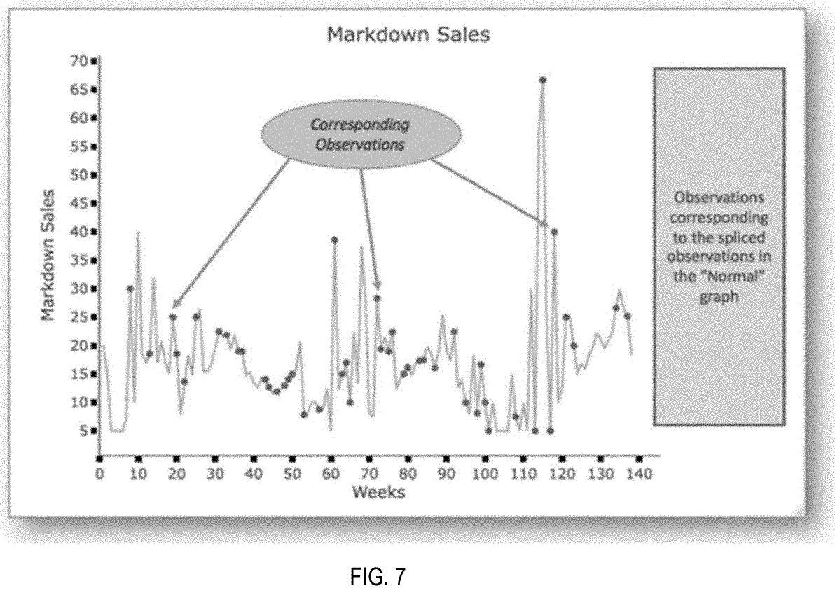

FIG. 7 is an exemplary diagram displaying markdown series corresponding the spliced random points in the normal sales data in the spliced corresponding observation regions.

In step 310, a user interface receives one or more markdown plans predefined by a user and the markdown plans may comprise a plurality of review gates. In some embodiments, a user can enter multiple markdown plans. Since the historical sales data do not change for different markdown plans, the system can easily compute individual forecasts along with relevant metrics for each plan and return them to the user via the user interface. The system may enable the user to assess and compare the effects of the plans via the user interface. Since the disruptive time series algorithm is extremely fast, the system can search for all possible combinations of markdown plans in real time with some user-defined constraints and come up with the most optimal plan based on the user's set criterion, such as minimum waste. The system may keep a record of the adoption rate of its suggested plan, as well as the user-defined plans, which will act as a feedback mechanism, so that over a period of time, the system can automatically fine-tune markdown plans specific to the user's behavior and generate user-specific markdown plans.

In some embodiments, the system may provide multiple markdown plans based on the user defined criterion, such as Maximize Sell-Through, Minimize Loss of Revenue, Minimize Waste, etc. The user can choose these markdown plans according to the user's discretion. A user may always selects markdown plans similar to the Maximize Sell-Through Plan over the other markdown plans. The system can understand that the user's optimal plan is Maximize Sell-Through and suggest the Maximize Sell-Through Plan to the user. The user may not know beforehand whether the user's plan generates Maximize Sell-through or Minimize Waste, etc. The system can determine and cluster the markdown plans into these above categories and determine the optimal plan based on the user's history.

In step 312, the system may perform prediction on each disruptive time series using a Seasonal Autoregressive Integrated Moving Average (SARIMA) model with exogenous input X being trained on the disruptive time series to predict the stock on hand for the predefined markdown plans at each review gate.

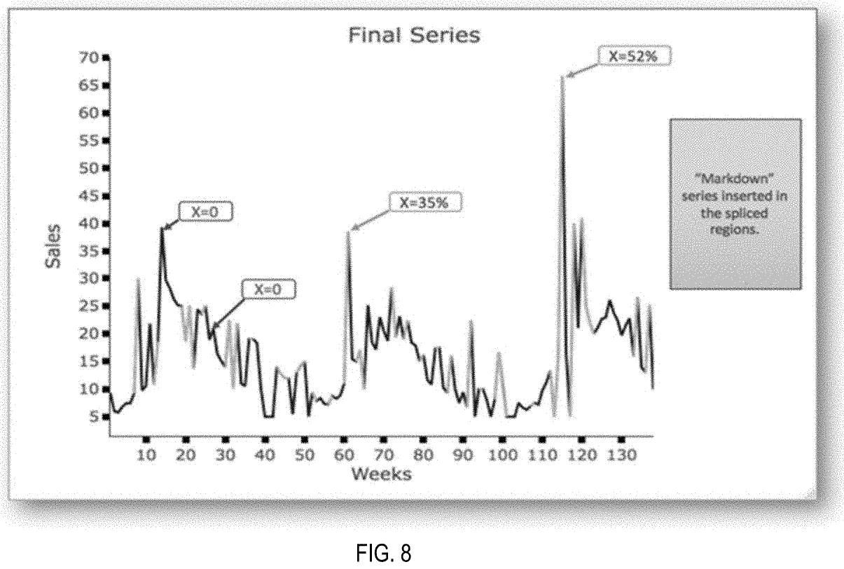

FIG. 8 is an exemplary diagram displaying the final sales prediction with observation markdown observation a final sales prediction. As illustrated in FIG. 8, the analysis is performed on this mixed series, with the addition of an exogenous variable X, which is 0 for all points corresponding to tₙₒᵣₘₐₗ and directly proportional to the markdown percentage for points corresponding to t_{markdown}. The seasonal auto-regressive moving average model (SARIMA) with exogenous input X is trained on this mixed series to predict the stock on hand for the entered markdown plan at each review gate. The predictions from each of these series are averaged out to find the final sales prediction at each review gate.

In step 314, the predictions from each disruptive time series may be combine and averaged out to find a final sales prediction at each review gate. The system may also modify its tₙₒᵣₘₐₗ and t_{markdown} series as it observes more data during the time the markdown is live, and display and sends live forecasts to the user regarding the performance of the markdown plan.

In step 316, the system uses this final prediction to compute the predicted stock on hand and a predicted incremental impact at each gate.

The incremental impact of markdown gates in the plan needs to be calculated based on the projected stock on hand. To predict or forecast stock on hand, the system needs to take current stock on hand and reduce the stock on hand for each subsequent gate based on the burn rate calculated by the system. This can provide more reliable financial impacts created by markdown plans.

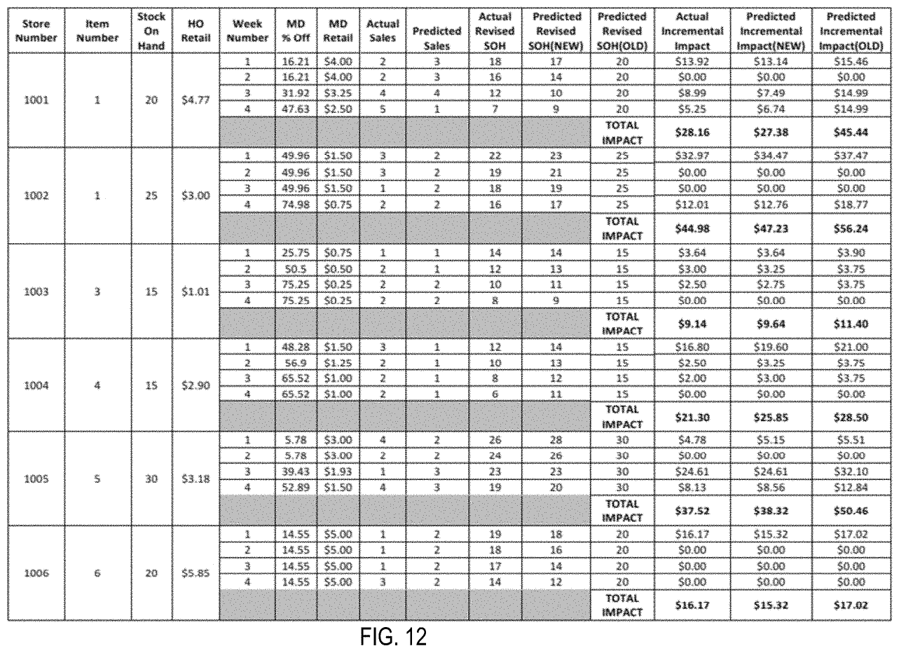

An incremental impact refers to the cash impact (e.g., dollar value of the items sold at a reduced price) at each review gate over the previous review gate. For example, referring to FIG. 12, for item #1 in store 1001, out of 20 items (e.g., Stock on Hand) are marked down; 2 items are sold after the first gate; it remains at 2 at the 2^{nd} gate, i.e., no item is sold. Therefore, the incremental impact at the 2^{nd} Gate is $0. That is, no item is sold with respect to the previous gate. The sales is increased to 4 at the 3^{rd} Gate (i.e., 2 items are sold), and so on. The incremental impact at the 3^{rd} gate is 2*marked down price. The system may compare how close the current model can predict the incremental impact with respect to the existing model. For example, in the same example, the actual impact is $28.16; the predicted impact of current model is $27.38 while the predicted impact for the existing model is $45.44. Hence the current model is much closer to the actual impact as compared to the existing model.

In step 318, the system may rerun the disruptive time series model to automatically recalculate and display the predicted stock on hand and the predicted incremental impact in real time on the user interface when the process receives a change made on the markdown plans. The system may return the predicted stock on hand at each gate to a user via the user interface dynamically. In some embodiments, while the system returns the predicted stock on hand at each gate, the system may also recommend various optimal markdown plans with respect to various key performance indicators (KPIs) based on the user's discretion. For example, with the predicted impact and stock on hand, the user may also want to know the most optimal plan with respect to minimizing the total waste. The user may also want to know another optimal plan with respect to the Highest Sale-Through Rate. The system may then provide two different markdown plans respectively.

In some embodiments, the system returns the impact at the time the markdown plan is made much before the markdown plan is actually implemented in the store. Once the markdown plan is implemented live in the store, the system automatically sends updated impacts each day the plan is live in store. For example, if the system predicts a sales of 2 units in the first review gate (e.g., week 1) and 3 items get sold are sold within 2 days, the system may modify its prediction by considering those sales records.

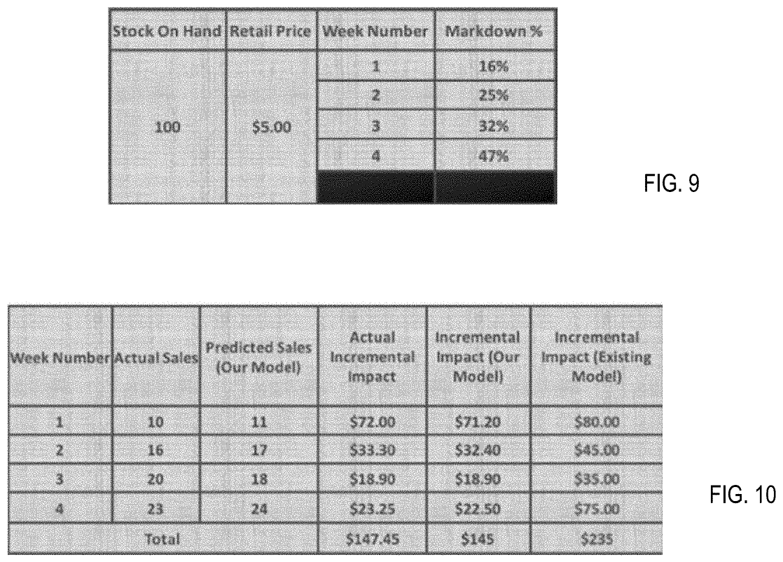

FIG. 9 shows an exemplary table illustrating a group of predefined markdown plans for 4 weeks for an item. FIG. 10 shows an exemplary table illustrating a predicted final sales and related information including actual sales for each week and predicated sales based on the illustrated process. FIG. 10 shows an example result produced by a markdown plan with a group of automatically calculated parameters, such as actual sales, predicted sales, actual incremental impact, predicted incremental impact and existing incremental impact. Moreover, the parameters shown in FIG. 10 include the aggregated level incremental impacts of the current model (e.g., system) and incremental impacts of an existing system with multiple markdown plans implemented within 4 weeks.

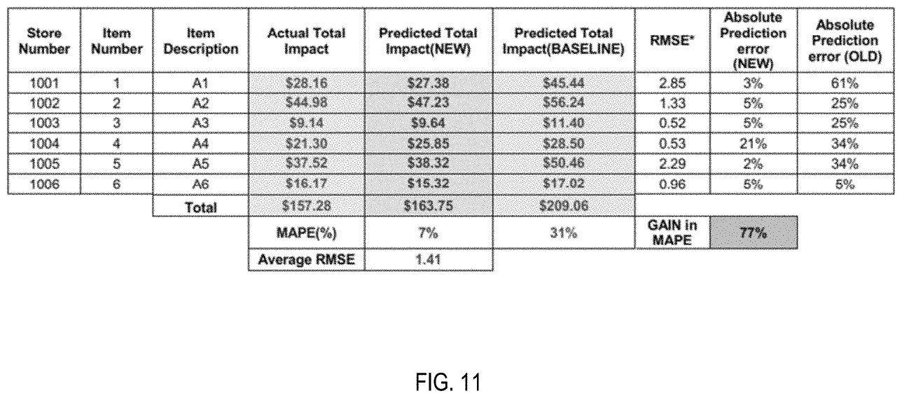

FIG. 11 is an exemplary table illustrating a comparison of predicted results between the disclosed system and the existing system in accordance with some embodiments. FIG. 11 shows predicated results on 6 store-item combinations for the “TOYS” department and comparison with the baseline. The results obtained with the current process are marked as “NEW” and the existing baseline results are marked as “BASELINE”. Additionally, FIG. 11 shows a total aggregated actual and predicted impacts for all markdown plans for 6 different sales items in 6 stores.

Root-Mean-Square Error (RMSE) is a frequently used measure of the differences between values (sample or population values) predicted by a model or an estimator and the values observed. As illustrated in FIG. 11, for example, the Disruptive Time Series Algorithm-based system are implemented on 50 store-item combinations for the “Toys” Department. It yields RMSE as low as 1.41, indicating that on an average, the predicted Stock on Hand will lie within ±1.5 range of the actual. The present system may be compared with the existing system by calculating the corresponding Maximum Absolute Percentage Error (MAPE) values for the Dollar Impact. The system may use the total aggregated actual and predicted impacts to calculate corresponding MAPE values for the dollar impact for evaluating the markdown plans provided by the user. The MAPE for the existing model can be represented by the following equation (1).

$$MAPE = \frac{Actual Impact - Predicted Total Impact}{Actual Impact} \qquad ( 1 )$$

For example, as shown in FIG. 11, the MAPE for the existing model is determined to be 31% based on the actual total impact and predicted total impact (Baseline). The MAPE for the current model is determined to be 7% based on the actual total impact and predicted total impact (New). A MAPE of 7% for the present system may be compared to a MAPE of 31% for the existing system to obtain an MAPE gain for evaluating an improvement. The MAPE gain is computed by the processor to be 77% for the new model (e.g., (31−7)/31 equals to 77%). The system uses a novel disruptive time series model which improves upon the existing system by providing 77% more accurate predictions for the stock on hand and other metrics such as overall dollar impact.

FIG. 12 is an exemplary table illustrating predicted final sales and actual final sales results along with the system parameters comparison when the disclosed process is applied to more store-item combinations with different predefined markdown plans. As shown in FIG. 12, the stock on hand (e.g., SOH (NEW)) can reduce over a period of 4 weeks with the new system based on different markdown plans. Pricing managers can use this system to obtain accurate forecasts of the consequences of their predefined markdown plans.

For example, as shown in FIG. 12, the first markdown plan is associated with an item #1 in a store #1001. The total actual impact for the markdown plans is $28.16. The total predicted incremental impact of the existing model is $45.44. The total predicted incremental impact of the current model is $27.38. Thus, the total predicted incremental impact $28.16 of the current model is much closer to the total actual impact $27.38. The difference between the total predicted incremental impact of the current model and the total actual impact is $0.78 with a MAPE of 3% (e.g., 0.78/27.38) as compared to the existing model with an impact difference of $17.28 (e.g., $45.44−$28.16) with a MAPE of 61% (e.g., 17.28/28.16). Lesser the MAPE, better is the Prediction Accuracy. Other markdown plans shown in FIG. 12 provide the similar results. That is, the current model provides better results in predicting stock on hand.

In some embodiments, the system can be used to alert users to alter one or more markdown plans if it detects anomalous behavior in the sales pattern. For example, if a markdown plan is live for six weeks, and the system detects unusually high sales within the first two weeks, it may automatically alert the user to reduce the markdown percentages for the remaining four weeks via user interface.

In some embodiments, the system can learn user behavior patterns over time, and provide personalized optimized markdown plans specific to the users.

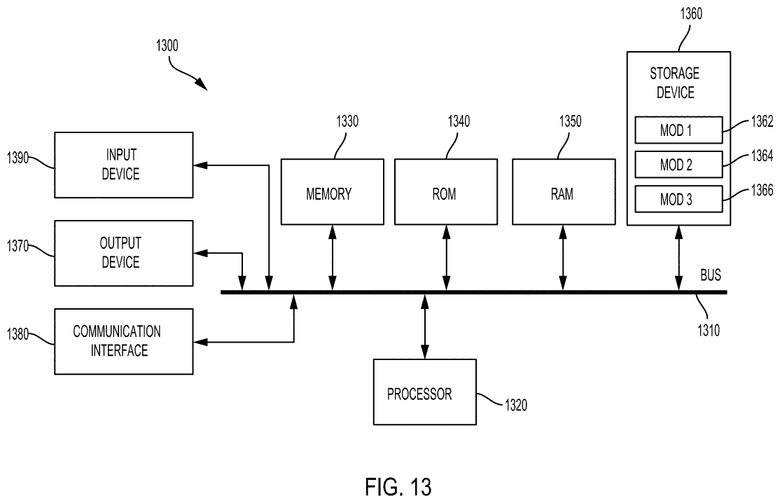

FIG. 13 illustrates an example computer system 1300 which can be used to may be used to implement embodiments as disclosed herein. The computing system 1300 may be a server, a personal computer (PC), or another type of computing device. The exemplary system 1300 can include a processing unit (CPU or processor) 1320 and a system bus 1310 that couples various system components including the system memory 1330 such as read only memory (ROM) 1340 and random access memory (RAM) 1350 to the processor 1320. The system 1300 can include a cache of high speed memory connected directly with, in close proximity to, or integrated as part of the processor 1320. The system 1300 copies data from the memory 1330 and/or the storage device 1360 to the cache for quick access by the processor 1320. In this way, the cache provides a performance boost that avoids processor 1320 delays while waiting for data. These and other modules can control or be configured to control the processor 1320 to perform various actions. Other system memory 1330 may be available for use as well. The memory 1330 can include multiple different types of memory with different performance characteristics. It can be appreciated that the disclosure may operate on a computing device 1300 with more than one processor 1320 or on a group or cluster of computing devices networked together to provide greater processing capability. The processor 1320 can include any general purpose processor and a hardware module or software module, such as module 1 1362, module 2 1364, and module 3 1366 stored in storage device 1360, configured to control the processor 1320 as well as a special-purpose processor where software instructions are incorporated into the actual processor design. The processor 1320 may essentially be a completely self-contained computing system, containing multiple cores or processors, a bus, memory controller, cache, etc. A multi-core processor may be symmetric or asymmetric.

The system bus 1310 may be any of several types of bus structures including a memory bus or memory controller, a peripheral bus, and a local bus using any of a variety of bus architectures. A basic input/output (BIOS) stored in ROM 1340 or the like, may provide the basic routine that helps to transfer information between elements within the computing device 1300, such as during start-up. The computing device 1300 further includes storage devices 1360 such as a hard disk drive, a magnetic disk drive, an optical disk drive, tape drive or the like. The storage device 1360 can include software modules 1362, 1364, 1366 for controlling the processor 1320. Other hardware or software modules are contemplated. The storage device 1360 is connected to the system bus 1310 by a drive interface. The drives and the associated computer-readable storage media provide non-volatile storage of computer-readable instructions, data structures, program modules and other data for the computing device 1300. In one aspect, a hardware module that performs a particular function includes the software component stored in a tangible computer-readable storage medium in connection with the necessary hardware components, such as the processor 1320, bus 1310, display 1370, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 1300 is a small, handheld computing device, a desktop computer, or a computer server.

Although the exemplary embodiment described herein employs the hard disk 660, other types of computer-readable media which can store data that are accessible by a computer, such as magnetic cassettes, flash memory cards, digital versatile disks, cartridges, random access memories (RAMs) 1350, and read only memory (ROM) 1340, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 1300, an input device 1390 represents any number of input mechanisms, such as a microphone for speech, a touch-sensitive screen for gesture or graphical input, keyboard, mouse, motion input, speech and so forth. An output device 1370 can also be one or more of a number of output mechanisms known to those of skill in the art. In some instances, multimodal systems enable a user to provide multiple types of input to communicate with the computing device 1300. The communications interface 1380 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

What is claimed is:

1. A computer-implemented method of predicting a stock on hand for predefined markdown plans, the method comprising:
retrieving, by a processor of a computing device, retail item sales data from a database;
aggregating, by the processor, normal sales and markdown sales associated to an item and one or more stores over a given period;
converting, by the processor, normal sales and markdown sales to a weekly time series normal sales and a weekly time series markdown sales;
creating, using a disruptive time series model, a plurality of disruptive time series, wherein each disruptive time series is created by:
splicing different parts of the weekly time series normal sales at random points; and
inserting the weekly time series markdown sales at corresponding points to spliced regions of the weekly time series normal sales until all the points in the weekly time series markdown sales are exhausted,
receiving, via a user interface, one or more markdown plans predefined by a user, the markdown plans comprising a plurality of review gates;
performing prediction on each disruptive time series using a Seasonal Autoregressive Integrated Moving Average (SARIMA) model with exogenous inputs being trained on the disruptive time series to predict and display the stock on hand for the predefined markdown plans at each review gate;
obtaining an average of predictions from each disruptive time series to find a final sales prediction at each review gate;
calculating, using the final sales prediction, a predicted stock on hand and a predicted incremental impact at each gate; and
rerunning the disruptive time series model to automatically recalculate and display the predicted stock on hand and the predicted incremental impact in real time when the processor receives a change made on the markdown plans.

2. The method of claim 1, further comprises:
when the aggregating is made across a plurality of stores, calculating average values of the weekly time series normal sales and the weekly time series markdown sales.

3. The method of claim 1, further comprises:
when the markdown plans are performed or entered by the user for a same store-item combination in a previous run, accessing markdown plans directly to speed up computation.

4. The method of claim 1, further comprises:
calculating an actual stock on hand and an actual incremental impact based on actual sales at each gate; and
evaluating the markdown plans for each item by calculating a Maximum Absolute Percentage Error (MAPE) value with the predicted incremental impact with the actual incremental impact at each gate.

5. The method of claim 1, wherein the points are roughly selected as one third of a total length of the weekly time series normal sales.

6. The method of claim 1, wherein the markdown plans are loaded or entered by the user via a user interface.

7. The method of claim 1, further comprises:
automatically calculating metrics such as loss of revenue, waste value, and sending them to the user.

8. The method of claim 1, further comprises:
returning the predicted stock on hand at each gate to a user via the user interface dynamically.

9. The method of claim 1, further comprises:
modifying the weekly time series normal sales and the weekly time series markdown sales as more data are observed during the time the markdown is live; and
sending live forecasts to the user regarding the performance of the markdown plans.

10. A system for predicting a stock on hand for predefined markdown plans, comprising:
a processor of a computing device;
a computer program product containing executable instructions; and
a computer-readable non-transitory storage medium having the executable instructions stored which, when executed by the processor, cause the processor to perform operations comprising:
retrieving, by the processor, retail item sales data from a database;
aggregating, by the processor, normal sales and markdown sales associated to an item and one or more stores over a given period;
converting, by the processor, normal sales and markdown sales to a weekly time series normal sales and a weekly time series markdown sales;
creating, using a disruptive time series model, a plurality of disruptive time series, wherein each disruptive time series is created by:
splicing different parts of the weekly time series normal sales at random points; and
inserting the weekly time series markdown sales at corresponding points to spliced regions of the weekly time series normal sales until all the points in the weekly time series markdown sales are exhausted,
receiving, via a user interface, one or more markdown plans predefined by a user, the markdown plans comprising a plurality of review gates;
performing prediction on each disruptive time series using a Seasonal Autoregressive Integrated Moving Average (SARIMA) model with exogenous input being trained on the disruptive time series to predict the stock on hand for the predefined markdown plans at each review gate;
obtaining an average of predictions from each disruptive time series to find a final sales prediction at each review gate;
calculating, using the final sales prediction, a predicted stock on hand and a predicted incremental impact at each gate; and
rerunning the disruptive time series model to automatically recalculate and display the predicted stock on hand and the predicted incremental impact in real time when the processor receives a change made on the markdown plans.

11. The system of claim 10, further comprises:
when the aggregating is made across a plurality of stores, calculating average values of the weekly time series normal sales and the weekly time series markdown sales.

12. The system of claim 10, further comprises:
when the markdown plans are performed or entered by the user for a same store-item combination in a previous run, accessing markdown plans directly to speed up computation.

13. The system of claim 10, further comprises:
calculating an actual stock on hand and an actual incremental impact based on actual sales at each gate; and
evaluating the markdown plans for each item by calculating a Maximum Absolute Percentage Error (MAPE) value with the predicted incremental impact with the actual incremental impact at each gate.

14. The system of claim 10, wherein the points are roughly selected as one third of a total length of the weekly time series normal sales.

15. The system of claim 10, wherein the markdown plans are loaded or entered by the user via a user interface.

16. The system of claim 10, further comprises:
automatically calculating metrics such as loss of revenue, waste value, and sending them to the user.

17. The system of claim 10, further comprises:
returning the predicted stock on hand at each gate to a user via the user interface dynamically.

18. The system of claim 10, further comprises:
modifying the weekly time series normal sales and the weekly time series markdown sales as more data are observed during the time the markdown is live; and
sending live forecasts to the user regarding the performance of the markdown plans.

19. A computer program product being embodied thereon a non-transitory computer-readable storage medium and comprising instructions which, when executed by one computing device, are configured to cause the computing device to perform operations comprising:
retrieving, by a processor of a computing device, retail item sales data from a database;
aggregating, by the processor, normal sales and markdown sales associated to an item and one or more stores over a given period;
converting, by the processor, normal sales and markdown sales to a weekly time series normal sales and a weekly time series markdown sales;
creating, using a disruptive time series model, a plurality of disruptive time series, wherein each disruptive time series is created by:
splicing different parts of the weekly time series normal sales at random points; and
inserting the weekly time series markdown sales at corresponding points to spliced regions of the weekly time series normal sales until all the points in the weekly time series markdown sales are exhausted,
receiving, via a user interface, one or more markdown plans predefined by a user, the markdown plans comprising a plurality of review gates;
performing prediction on each disruptive time series using a Seasonal Autoregressive Integrated Moving Average (SARIMA) model with exogenous input being trained on the disruptive time series to predict a stock on hand for the predefined markdown plans at each review gate;
obtaining an average of predictions from each disruptive time series to find a final sales prediction at each review gate;
calculating, using the final sales prediction, a predicted stock on hand and a predicted incremental impact at each gate; and
rerunning the disruptive time series model to automatically recalculate and display the predicted stock on hand and the predicted incremental impact in real time when the processor receives a change made on the markdown plans.

20. The computer program product of claim 19, wherein the operations further comprises:
when the aggregating is made across a plurality of stores, calculating average values of the weekly time series normal sales and the weekly time series markdown sales.
